(19) United States
(12) Patent Application Publication
(10) Pub. No.: US 2004/0097629 A1
(43) Pub. Date: May 20, 2004

(54) Prepolymer and dielectric material produced therefrom

(76) Inventors: Wilfried Aichele, Winnenden (DE); Gerd Scheying, Stuttgart (DE); Lutz Mueller, Aichtal (DE); Oliver Roesch, Stuttgart (DE); Marco Munk, Aichwald-Aichschiess (DE)

Correspondence Address: KENYON & KENYON, ONE BROADWAY, NEW YORK, NY, 10004, US

(21) Appl. No.: 10/450,922

(22) PCT Filed: Dec. 1, 2001
(86) PCT No.: PCT/DE01/04514

(30) Foreign Application Priority Data
Dec. 6, 2000 (DE) 100 60 571.0

(51) Int. Cl. C08K 3/18

(52) U.S. Cl. 524/431

(57) ABSTRACT

A prepolymer, which contains at least one linear polymerizing monomer and one photoinitiator, and one dielectric material, which is produced in particular from one such prepolymer by polymerization, is used to provide a structurable prepolymer and a thermostable, moisture insensitive and low-loss dielectric polymer material producible therefrom and having low dielectric losses (tan δ), for high-frequency and microwave circuits in particular.

### BACKGROUND INFORMATION

The present invention relates to a prepolymer and dielectric materials produced therefrom, for multilayer circuits in particular.

Microwave circuits, multilayer circuits in particular, made from low-loss dielectric materials provided with a metallic coating are known. The dielectrics are based either on Teflon, for example, on a product available from Rogers Corp. Chandler, Ariz., USA under the name RT/duroid® 6002, or on polyparaxylene (available under the name Parylene N), monochloropolyparaxylene (Parylene C), dichloropolyparaxylene (Parylene D) and perfluoro-p-xylylene (a product of Union Carbide Corp.), which have a higher thermostability compared to Teflon.

In high-frequency capacitors, polystyrene in the form of a film is used as a moisture-resistant dielectric material. Polystyrene is a thermoplastic (meltable) plastic. Polymerizable casting resins of polystyrene dissolved in styrene are also known. If polystyrene has inadequate thermostability, it can be improved by copolymerization of styrene with linear polymerizing monomers such as α-methylstyrene. The resultant copolymers are thermoplastics. Another possibility of improving the thermostability is to cross-link styrene or styrene derivatives with cross-linking comonomers such as divinylbenzene. This produces thermosetting styrene copolymers that are used, for example, as ion-exchange resins.

The structuring of UV-curing casting resins using photolithography is a known method. A surface is coated by spinning on a liquid resin or one dissolved in a solvent, the solvent is flashed off if necessary, the coating is exposed through a mask and the unexposed areas of the resin layer are removed using a solvent.

### SUMMARY OF THE INVENTION

An object of the invention is to provide a structurable prepolymer and a thermostable, moisture insensitive, low-loss dielectric polymer material producible therefrom and having a low loss factor tan δ, for high-frequency and microwave circuits in particular. A prepolymer is understood to be a precursor of a polymer.

The dielectric materials of the present invention produced from the prepolymer of the present invention have little attenuating effect on electromechanical waves, even those in the high-frequency and microwave range, making it possible to transport high-frequency energy more efficiently. For that reason, the dielectric material is not heated by the electromagnetic waves passing through. The prepolymer of the present invention is photostructurable, preferably using UV light. It is therefore possible to produce holes for through contacts in a simple manner, for which reason the dielectric materials of the present invention may be used to particular advantage in multilayer circuits, or circuits may be produced that have a dielectric material only in certain areas. The photoinitiator need only be added in quantities (preferably—based on the total weight of the prepolymer—between approximately 0.1 and approximately 5 wt.-%) that do not significantly increase the attenuation of the electromagnetic waves.

To produce a polymer that is of low loss in particular, it is advantageous if the linear polymerizing monomer is styrene.

To reduce the vapor pressure of the prepolymer and/or to increase the thermostability of the dielectric material produced, it is advantageous if the styrene is completely or partially replaced by at least one linear polymerizing monomer from the group α-methylstyrene, o-, p, and m-vinyltoluene, a mixture of cis- and trans-stilbene, α- and β-pinene, indene, o-, p- and m-methoxystyrene and o-, p- and m-ethylstyrene. The polymers produced from such prepolymers are considerably more thermostable than, for example, normal homopolymer polystyrene having a glass transition temperature of approximately +100° C. The higher thermostability has no influence on the energy losses.

It is advantageous if the photoinitiator is an initiator for the radical polymerization, preferably Darocur® 1173 or Irgacure® 369.

At least one cross-linking polymerizing monomer in the prepolymer advantageously also contributes to increasing the thermostability of the dielectric material to be produced without therefore causing the occurrence of greater dielectric losses than with polystyrene. Of particular advantage as a cross-linking polymerizing monomer is at least one material from the group divinylbenzene, methylcyclopentadiene, norborna-2,5-diene, indene, α-, β- and γ-terpinene, dipentene and dicyclopentadiene. The cross-linked, homogeneous copolymers produced are thermosetting materials.

To increase the storage life of the prepolymer, it is favorable if the prepolymer contains a stabilizing agent.

In order to set a desired viscosity, it is advantageous if the prepolymer contains a solvent such as butyl acetate.

It is advantageous if a polymer, preferably thermoplastic polystyrene or an indene resin, is dissolved in the prepolymer as a film-forming agent.

To improve the chemical and thermal stability and to further improve the dielectric characteristics of the dielectric material to be produced, it is advantageous if the hydrogen atoms in the monomers and in the polymer, if necessary, are entirely or partially replaced by fluorine atoms.

In order to be able to vary the dielectric constant of the dielectric material of the present invention, it is advantageous if the prepolymer of the present invention contains a filler of inorganic particles, preferably hydrophobic TiO₂.

A dielectric material, which is very low loss in the high-frequency and microwave range and very thermostable if the composition is appropriate, is obtained when the prepolymer, based on its total weight, contains approximately 5 to approximately 95 wt.-% of at least one of the cited linear polymerizing monomers, approximately 0 to approximately 50 wt.-% of at least one of the cited cross-linking monomers, approximately 0 to approximately 50 wt.-% of one of the cited polymers and less than approximately 5 wt.-% of one of the cited photoinitiators.

A dielectric material which is particularly dense is obtained advantageously if solvent which may, if necessary, be present in the prepolymer is removed before the polymerization.

The dielectric material of the present invention may be used advantageously in high-frequency and microwave circuits and to particular advantage in multilayer high-frequency and microwave circuits.

### DETAILED DESCRIPTION

The invention will be described in detail below with reference to exemplary embodiments. However, it should be understood that the invention may be explained clearly in particular using these examples but a plurality of deviations are possible from them in the context of the claims.

Generally, the prepolymer of the present invention, from which the dielectric material of the present invention is produced, contains at least one monomer, one photoinitiator and if necessary—to obtain specific characteristics—yet additional additives (see below). The monomers are exclusively those that form macromolecular chains or networks by polymerization.

The homopolymer obtained through polymerization of the linear polymerizing styrene is itself moisture insensitive and extraordinarily low loss; however the prepolymer containing only styrene (b.p. 145° C.) as a monomer has a relatively high vapor pressure and the thermostability of the polystyrene is not adequate for many applications since it has a glass transition temperature of only approximately +100° C. There are several possibilities for obtaining a more thermostable polymer, the dielectric losses of which do not exceed those of polystyrene.

It is possible to replace the styrene entirely or partially by at least one linear polymerizing monomer having a higher boiling point than styrene. Such monomers are selected in particular from the group α-methylstyrene (b.p. 165° C.), o-, p- and m-vinyltoluene (b.p. 172° C.), a mixture of cis- and trans-stilbene (b.p. 306-307° C.), trans-stilbene component 0 to 100 wt.-%), α- and β-pinene (b.p. 155° C.), indene (b.p. 182° C.), o-, p- and m-methoxystyrene (b.p. of the p-compound 204° C.) and o-, p- and m-ethylstyrene (b.p. >120° C.). It is possible in this way to reduce the vapor pressure of the prepolymer. Independent of its vapor pressure, it is possible to increase the thermoformability of the thermosetting plastic obtained by selecting a suitable monomer.

In addition to the linear polymerizing monomer or the linear polymerizing monomers, it is possible to add at least one cross-linking monomer. These cross-linking monomers include in particular materials from the group divinylbenzene (b.p. 200° C.), methylcyclopentadiene (b.p. 98° C. at 40 hPa), norborna-2,5-diene (b.p. 89° C.), indene (b.p. 182° C.), α- and β-terpinene (b.p. 174° C.), γ-terpinene (b.p. 183° C.), dipentene (b.p. 178° C.) and dicyclopentadiene (b.p. 98° C. at 54 hPa), divinylbenzene being preferred in particular due to its high boiling point. The thermosetting material produced in the polymerization has an even higher thermoformability than when only linear polymerizing monomers are used.

As a photoinitiator, a radical initiator, Darocur® 1173 or Irgacure® 369 being preferred in particular, is added to the prepolymer in quantities of approximately 0.1 to approximately 5 wt.-%, based on the total weight of the prepolymer. Darocur® 1173 and Irgacure® 369 are made up of 2-hydroxy-2-methyl-1-phenyl-1-propanone and 2-benzyl-2-N,N-dimethylamino-1-(4-morpholinophenyl)-1-butanone, respectively, and are marketed by Ciba-Geigy, Basel, Switzerland.

Because the prepolymer is photopolymerizable and is therefore selectively structurable, it may be used very advantageously in the production of the presently customary microelectronic multilayer circuits, it being necessary to produce holes in the dielectric material for through contacts, or it may be used in circuits having a dielectric material only in certain areas.

To increase the storage life, the prepolymer may contain one of the customary stabilizing agents, such as a phenolic inhibitor to prevent premature polymerization.

To adjust the viscosity of the prepolymer, which is applied for example by spinning on, to a suitable value, it is possible to add a solvent such as butyl acetate to the mixture if necessary.

So that the polymer forms a coherent film, it is advantageous if the prepolymer contains a film-former. Primarily thermoplastic polystyrene may be considered as a film-former which may be entirely or partially replaced by a thermoplastic, which is also soluble in the prepolymer and has a higher thermostability than polystyrene, such as indene resins (see Hans Wagner, Hans Friedrich Sarx “Lackkunstharze [Synthetic Resins for Paints],” Carl Hanser Verlag, Munich, ISBN 3-446-10377-6).

Another embodiment makes use of filling with inorganic particles such as hydrophobic TiO₂, to vary the dielectric constant δᵣ.

All of the monomers and polymers used in the prepolymer may also be products in which all or a part of the hydrogen atoms are replaced by fluorine atoms, such as pentafluorostyrene.

In order to produce the dielectric material, the prepolymer, which forms a viscous solution, is applied in a known manner, for example, by spinning onto a substrate, for example, a printed circuit board substrate, a semiconductor wafer or a ceramic substrate. For polymerization, the applied layer is irradiated with UV light. If the layer is to be structured, the UV light is selectively screened, for example by a mask. The irradiation causes the layer to be cured, in areas if necessary. Unexposed areas are then dissolved away with methylisobutylketone, for example. Then, it is possible to apply printed conductors in a known manner. It is possible to build up multilayer circuits by single or multiple repetition of the cited steps.

In a preferred exemplary embodiment, the constituents of the prepolymer are mixed together homogeneously into a viscous solution. Based on its total weight, the mixture contains approximately 5 to approximately 95 wt.-% of at least one linear polymerizing monomer, approximately 0 to approximately 50 wt.-% of thermoplastic film-formers, approximately 0 to approximately 50 wt.-% of at least one cross-linking monomer, less than approximately 5 wt. % photoinitiator and if necessary—depending on the application—additional additives (see above). The constituents of the mixture are selected from the aforementioned materials. The polymerization takes place as specified above. Provided that a cross-linking monomer is present—a three-dimensional cross-linked thermoplastic material is formed.

Typical parameters of the dielectric material produced:

Loss factor tan δ=3·10⁻³ and

Dielectric constant εᵣ=2.35 (at 40 GHz)

This ensures that the material produced is extremely low loss in the high-frequency and microwave range.

What is claimed is:

1. A prepolymer,
wherein it contains at least one linear polymerizing monomer and one photoinitiator.

2. The prepolymer as recited in claim 1,
wherein the linear polymerizing monomer is styrene.

3. The prepolymer as recited in claim 2,
wherein the styrene is completely or partially replaced by at least one linear polymerizing monomer from the group α-methylstyrene, o-, p-, and -vinyltoluene, a mixture of cis- and trans-stilbene, α- and β-pinene, indene, o-, p- and m-methoxystyrene and o-, p- and m-ethylstyrene.

4. The prepolymer as recited in one of claims 1 through 3,
wherein the photoinitiator is present in quantities between approximately 0.1 and approximately 5 wt.-%, based on the total weight of the prepolymer.

5. The prepolymer as recited in one of claims 1 through 4,
wherein the photoinitiator is a UV initiator.

6. The prepolymer as recited in one of claims 1 through 5,
wherein the photoinitiator is an initiator for the radical polymerization.

7. The prepolymer as recited in claim 6,
wherein Darocur® 1173 or Irgacure® 369 is contained as a photoinitiator.

8. The prepolymer as recited in one of claims 1 through 7,
wherein it contains at least one cross-linking polymerizing monomer.

9. The prepolymer as recited in claim 8,
wherein the cross-linking polymerizing monomer is at least one material from the group divinylbenzene, methylcyclopentadiene, norborna-2,5-diene, indene, ≢-, β- and γ-terpinene, dipentene and dicyclopentadiene.

10. The prepolymer as recited in one of claims 1 through 9,
wherein it contains a stabilizing agent.

11. The prepolymer as recited in one of claims 1 through 10,
wherein it contains a solvent.

12. The prepolymer as recited in claim 11,
wherein butyl acetate is contained as a solvent.

13. The prepolymer as recited in one of claims 1 through 12,
wherein a polymer is dissolved in it.

14. The prepolymer as recited in claim 13,
wherein thermoplastic polystyrene or an indene resin is used as a polymer.

15. The prepolymer as recited in one of claims 1 through 14,
wherein the hydrogen atoms in the monomers and in the polymer, if necessary, are entirely or partially replaced by fluorine atoms.

16. The prepolymer as recited in one of claims 1 through 15,
wherein it contains inorganic particles as a filler.

17. The prepolymer as recited in claim 16,
wherein it contains hydrophobic TiO₂ as a filler.

18. The prepolymer as recited in one of claims 2 through 17,
wherein, based on its total weight, it contains approximately 5 to approximately 95 wt.-% of at least one of the cited linear polymerizing monomers, approximately 0 to approximately 50 wt.-% of at least one of the cited cross-linking monomers, approximately 0 to approximately 50 wt.-% of one of the cited polymers and less than approximately 5 wt.-% of one of the cited photoinitiators.

19. A dielectric material,
wherein it has been produced in particular by polymerization from the prepolymer as recited in one of claims 1 through 18.

20. The dielectric material as recited in claim 19,
wherein solvent which may, if necessary, be present is removed before the polymerization.

21. The dielectric material as recited in claim 19 or 20,
characterized by its use in high-frequency and microwave circuits.

22. The dielectric material as recited in claim 21,
wherein the high-frequency and microwave circuits are multilayered.
